(19) United States
(12) Patent Application Publication
(10) Pub. No.: US 2026/0016616 A1
(43) Pub. Date: Jan. 15, 2026

(54) OPTICAL LAMINATE AND IMAGE DISPLAY DEVICE USING SAME

(71) Applicant: TOPPAN TOMOEGAWA Optical Films Inc., Tokyo (JP)

(72) Inventors: Yuri NAGAI, Tokyo (JP); Satoshi Kanata, Tokyo (JP); Taira Kaneko, Tokyo (JP); Takumi Saito, Tokyo (JP)

(21) Appl. No.: 19/337,750

(22) Filed: Sep. 23, 2025

Related U.S. Application Data
(63) Continuation of application No. PCT/JP2024/023613, filed on Jun. 28, 2024.

(30) Foreign Application Priority Data
Jun. 29, 2023 (JP) 2023-107420

(51) Int. Cl. G02B 1/11

(52) U.S. Cl. CPC G02B 1/11

(57) ABSTRACT

Provided are an optical laminate that is excellent in sparkle resistance and fingerprint removability, and an image display device using the same. The optical laminate has an uneven shape on a topmost surface, and satisfies a condition (1): 800≤A≤5,500, and a condition (2): 0<B≤100. Here, A and B are values calculated from a second image obtained by performing fast Fourier transform on a first image obtained from three-dimensional data of unevenness heights obtained by measuring the uneven shape through optical interferometry or in a contact manner. A is an average value of power spectrum intensities in a range of 50 cycles/mm≤f≤100 cycles/mm, and B is an average value of power spectrum intensities in a range of 200 cycles/mm≤f≤250 cycles/mm.

### CROSS REFERENCE TO RELATED APPLICATION

This application is a continuation of International Application PCT/JP2024/023613 filed on Jun. 28, 2024, which claims benefit of Japanese patent application JP 2023-107420 filed on Jun. 29, 2023, both of which are incorporated herein by reference in their entireties.

### BACKGROUND

### Field

The present invention relates to an optical laminate and an image display device using the same.

### Description of the Related Art

An antiglare (AG) film is obtained by laminating an antiglare layer formed by a resin layer containing a filler, on a transparent substrate, and scatters reflection light by unevenness of an antiglare layer surface, thus preventing ambient light from appearing on the surface. There is also known an antiglare low reflection (AGLR) film which is formed by laminating a low-refractive-index layer (low reflection (LR) layer) on the antiglare layer of the AG film and suppresses reflection light using optical interference. The AG film and the AGLR film (hereinafter, collectively referred to as “antiglare property film”) are used for various displays.

In the antiglare property film, when light emitted from the inside of a display panel of a display passes through an uneven shape surface of the antiglare layer, the surface unevenness functions as a lens, so that “sparkle” which disturbs a display image is likely to occur. It is known that sparkle is mitigated by increasing a difference between the refractive index of resin and the refractive index of filler particles and causing internal scattering. However, in this case, a problem that the outer appearance is whitened is likely to occur. As display panels have increasingly higher definitions in recent years, suppression of the sparkle is required for antiglare panels (see, for example, Japanese Patent No. 7192777 and WO2019/026471).

### SUMMARY

An antiglare property film for a touch panel display with an antireflection function is required to have excellent removability for fingerprint deposited in operation, as well as antiglare property which is optical property. In order to exhibit fingerprint removability, it is general to contain a stain-proofing component such as a fluorine compound or a silicone compound in the layer at the topmost surface. However, merely adding such a stain-proofing component has a limitation in improving fingerprint removability.

Accordingly, an object of the present invention is to provide an optical laminate that is excellent in sparkle resistance and fingerprint removability, and an image display device using the same.

The present invention provides an optical laminate having an uneven shape on a topmost surface thereof and configured to satisfy the following conditions (1) and (2):

$$800 \leq A \leq 5 , 500 \qquad ( 1 )$$

$$0 < B \leq 100 \qquad ( 2 )$$

where,
when three-dimensional data of unevenness heights obtained by measuring the uneven shape through optical interferometry or in a contact manner is transformed to first image data in which the unevenness heights are pixel values, the first image data is transformed to a second image through fast Fourier transform, and spatial frequencies f at x coordinates of a power spectrum of an image in a range of ±20 pixels from a positive part of an x axis passing through an origin on the second image are calculated,
A is an average value of power spectrum intensities in a range of 50 cycles/mm≤f≤100 cycles/mm, and B is an average value of power spectrum intensities in a range of 200 cycles/mm≤f≤250 cycles/mm.

The present invention can provide an optical laminate that is excellent in sparkle resistance and fingerprint removability, and an image display device using the same.

These and other objects, features, aspects, and advantages of the present invention will become more apparent from the following detailed description when taken in conjunction with the accompanying drawings.

### BRIEF DESCRIPTION OF THE DRAWINGS

FIG. 1 is a sectional view schematically showing an example of an optical laminate according to an embodiment;

FIG. 2 is a sectional view schematically showing another example of the optical laminate according to the embodiment.

FIG. 3 shows an evaluation method for antiglare property; and

FIG. 4 shows an evaluation example of antiglare property.

### DETAILED DESCRIPTION

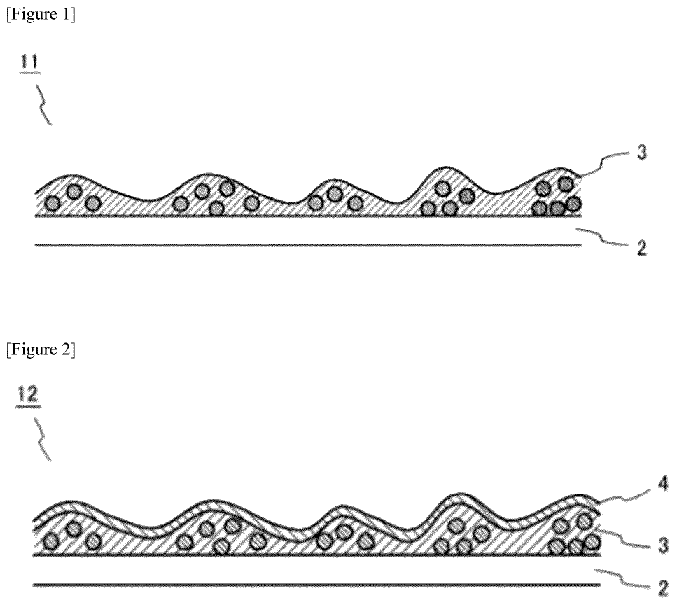

FIG. 1 is a sectional view schematically showing an example of an optical laminate according to an embodiment.

An optical laminate 11 includes a transparent substrate 2, and an antiglare layer (first function layer) 3 laminated on one surface of the transparent substrate 2. The optical laminate 11 is an optical film (also called “AG film”) that scatters incident light by a minute uneven shape of the surface of the antiglare layer 3 and thus inhibits ambient light from appearing on the surface.

The transparent substrate 2 is a film serving as a base body of the optical laminate 11, and is formed of a material that is excellent in visible light transmitting property. Examples of the material forming the transparent substrate 2 include inorganic glass, and transparent resins which are polyolefins such as polyethylene and polypropylene, polyesters such as polyethylene terephthalate, polybutylene terephthalate, and polyethylene naphthalate, polyacrylates such as polymethyl methacrylate, polyamides such as nylon 6 and nylon 66, polyimides, polyarylates, polycarbonate, triacetyl cellulose, polyacrylate, polyvinyl alcohol, polyvinyl chloride, cycloolefin copolymers, norbornene-containing resins, polyether sulfone, and polysulfone. The thickness of the transparent substrate 2 is not limited, and is preferably 10 to 200 μm.

The surface of the transparent substrate 2 may be subjected to surface modification treatment so as to have improved adhesion with another layer laminated thereon. Examples of the surface modification treatment include alkaline treatment, corona treatment, plasma treatment, sputtering treatment, application of a surfactant or a silane coupling agent, and Si vapor deposition.

The antiglare layer 3 is a function layer forming a minute uneven shape of the topmost surface of the optical laminate 11.

The antiglare layer 3 is formed by applying a coating liquid containing an active energy ray-curable compound and organic fine particles and/or inorganic fine particles (filler) onto the transparent substrate 2 and curing the coating film.

As the active energy ray-curable compound, for example, a monofunctional, bifunctional, trifunctional, or higher-functional (meth)acrylate monomer can be used. As used herein, the term “(meth)acrylate” collectively refers to both of acrylate and methacrylate, and the term “(meth)acryloyl” collectively refers to both of acryloyl and methacryloyl.

Examples of the monofunctional (meth)acrylate composite include 2-hydroxyethyl (meth)acrylate, 2-hydroxypropyl (meth)acrylate, 2-hydroxybutyl (meth)acrylate, n-butyl (meth)acrylate, isobutyl (meth)acrylate, t-butyl (meth)acrylate, glycidyl (meth)acrylate, acryloyl morpholine, N-vinylpyrrolidone, tetrahydrofurfuryl acrylate, cyclohexyl (meth)acrylate, 2-ethylhexyl (meth)acrylate, isobornyl (meth)acrylate, isodecyl (meth)acrylate, lauryl (meth)acrylate, tridecyl (meth)acrylate, cetyl (meth)acrylate, stearyl (meth)acrylate, benzyl (meth)acrylate, 2-ethoxyethyl (meth)acrylate, 3-methoxybutyl (meth)acrylate, ethyl carbitol(meth)acrylate, phosphoric (meth)acrylate, ethylene oxide-modified phosphoric (meth)acrylate, phenoxy (meth)acrylate, ethylene oxide-modified phenoxy (meth)acrylate, propylene oxide-modified phenoxy (meth)acrylate, nonylphenol (meth)acrylate, ethylene oxide-modified nonylphenol (meth)acrylate, propylene oxide-modified nonylphenol (meth)acrylate, methoxy diethylene glycol (meth)acrylate, methoxy polyethylene glycol (meth)acrylate, methoxy propylene glycol (meth)acrylate, 2-(meth)acryloyloxyethyl-2-hydroxypropyl phthalate, 2-hydroxy-3-phenoxypropyl (meth)acrylate, 2-(meth)acryloyloxyethyl hydrogen phthalate, 2-(meth)acryloyloxypropyl hydrogen phthalate, 2-(meth)acryloyloxypropyl hexahydro hydrogen phthalate, 2-(meth)acryloyloxypropyl tetrahydro hydrogen phthalate, dimethylaminoethyl (meth)acrylate, trifluoroethyl (meth)acrylate, tetrafluoropropyl (meth)acrylate, hexafluoropropyl (meth)acrylate, octafluoropropyl (meth)acrylate, 2-adamantan, and adamantane-derived mono(meth)acrylates such as adamantyl acrylate having monovalent mono(meth)acrylate derived from adamantanediol.

Examples of the bifunctional (meth)acrylate include di(meth)acrylates such as ethylene glycol di(meth)acrylate, diethylene glycol di(meth)acrylate, butanediol di(meth)acrylate, hexanediol di(meth)acrylate, nonanediol di(meth)acrylate, ethoxylated hexanediol di(meth)acrylate, propoxylated hexanediol di(meth)acrylate, diethylene glycol di(meth)acrylate, polyethylene glycol di(meth)acrylate, tripropylene glycol di(meth)acrylate, polypropylene glycol di(meth)acrylate, neopentyl glycol di(meth)acrylate, ethoxylated neopentyl glycol di(meth)acrylate, tripropylene glycol di(meth)acrylate, and hydroxypivalic acid neopentyl glycol di(meth)acrylate.

Examples of the trifunctional or higher-functional (meth)acrylate include tri(meth)acrylates such as trimethylolpropane tri(meth)acrylate, ethoxylated trimethylolpropane tri(meth)acrylate, propoxylated trimethylolpropane tri(meth)acrylate, tris(2-hydroxyethyl)isocyanurate tri(meth)acrylate, and glycerin tri(meth)acrylate, trifunctional (meth)acrylate compounds such as pentaerythritol tri(meth)acrylate, dipentaerythritol tri(meth)acrylate, and ditrimethylolpropane tri(meth)acrylate, polyfunctional (meth)acrylate compounds with three or more functional groups such as pentaerythritol tetra(meth)acrylate, ditrimethylolpropane tetra(meth)acrylate, dipentaerythritol tetra(meth)acrylate, dipentaerythritol penta(meth)acrylate, ditrimethylolpropane penta(meth)acrylate, dipentaerythritol hexa(meth)acrylate, and ditrimethylolpropane hexa(meth)acrylate, and polyfunctional (meth)acrylate compounds in which some of the above (meth)acrylates are substituted with an alkyl group or ε-caprolactone.

As the polyfunctional monomer, urethane (meth)acrylate can also be used. The urethane (meth)acrylate may be obtained by, for example, reacting a prepolymer or an isocyanate monomer with polyester polyol and then reacting the resulting product with a (meth)acrylate monomer having a hydroxyl group.

Examples of the urethane (meth)acrylate include pentaerythritol triacrylate hexamethylene diisocyanate urethane prepolymer, dipentaerythritol pentaacrylate hexamethylene diisocyanate urethane prepolymer, pentaerythritol triacrylate toluene diisocyanate urethane prepolymer, dipentaerythritol pentaacrylate toluene diisocyanate urethane prepolymer, pentaerythritol triacrylate isophorone diisocyanate urethane prepolymer, and dipentaerythritol pentaacrylate isophorone diisocyanate urethane prepolymer.

As the aforementioned polyfunctional monomer, one kind may be used or two or more kinds may be used in combination. The aforementioned polyfunctional monomer may be present as a monomer or as a partially polymerized oligomer, in the coating liquid.

The organic fine particles are a material mainly for forming minute unevenness on the surface of the antiglare layer 3 and thus imparting a function of scattering ambient light. The organic fine particles may be resin particles made of a light-transmitting resin material such as acrylic resin, polystyrene resin, styrene-(meth)acrylic acid ester copolymer, polyethylene resin, epoxy resin, silicone resin, polyvinylidene fluoride, and polyfluoroethylene-based resin. In order to adjust the refractive index or dispersion of the resin particles, two or more kinds of resin particles different in material (refractive index) may be mixed and used. The average particle size of the organic fine particles is preferably 0.5 to 10 μm.

The inorganic fine particles to be added to the antiglare layer formation composition are preferably nanoparticles with an average particle size of 10 to 200 nm.

The inorganic fine particles are a material mainly for adjusting sedimentation and aggregation of the organic fine particles in the antiglare layer 3. As the inorganic fine particles, silica fine particles, metal oxide fine particles, various mineral fine particles, or the like can be used. As the silica fine particles, for example, colloidal silica or silica fine particles surface-modified with a reactive functional group such as a (meth)acryloyl group can be used. As the metal oxide fine particles, for example, alumina, zinc oxide, tin oxide, antimony oxide, indium oxide, titania, and zirconia, can be used. As the mineral fine particles, for example, mica, synthetic mica, vermiculite, montmorillonite, iron montmorillonite, bentonite, bidellite, saponite, hectorite, stevensite, nontronite, magadiite, airalite, kanemite, layered titanate, smectite, and synthetic smectite, can be used. The mineral fine particles may be either natural or synthetic ones (including substitutes and derivatives), and a mixture of both may be used. Among mineral fine particles, layered organoclay is more preferable. Layered organoclay refers to clay in which organic onium ions are introduced between layers of swelling clay. The organic onium ions are not limited as long as they can be made organic by utilizing the cation exchange capacity of swelling clay. In a case of using layered organoclay minerals as the mineral fine particles, the aforementioned synthetic smectite can be preferably used. The synthetic smectite has a function of increasing viscosity of the antiglare layer formation composition, suppressing sedimentation of the resin particles and the inorganic fine particles, and adjusting the uneven shape of the surface of the optical function layer.

In order to cure the antiglare layer formation composition by ultraviolet irradiation, a polymerization initiator may be added. As the polymerization initiator, a polymerization initiator that produces radicals by ultraviolet irradiation can be used. As the polymerization initiator, a radical polymerization initiator such as acetophenone-based, benzophenone-based, thioxanthone-based, benzoin, benzoin methyl ether, and acyl phosphine oxides, and the like, can be used. Examples of the polymerization initiator include diphenyl (2,4,6-trimethylbenzoyl) phosphine oxide, bis(2,4,6-trimethylbenzoyl) phenyl phosphine oxide, 2,2-diethoxyacetophenone, 1-hydroxycyclohexyl phenyl ketone, 2,2-dimethoxy-phenyl acetophenone, dibenzoyl, benzoin, benzoin methyl ether, benzoin ethyl ether, p-chlorobenzophenone, p-methoxybenzophenone, Michler's ketone, acetophenone, and 2-chlorothioxanthone. Among these, one kind may be used alone, or two or more kinds may be used in combination.

As a component for improving stain-proofing property, a stain-proofing agent, a leveling agent, an oil repellent agent, a water repellent agent, and an anti-fingerprint agent are preferably added to the antiglare layer formation composition. As these additives, a fluorine-containing compound or a silicone compound can be favorably used. By adding a stain-proofing compound to the antiglare layer 3 to be the topmost layer, fingerprint removability can be further improved. Besides, various additives such as an antistatic agent, a defoaming agent, an antioxidant, an ultraviolet absorber, an infrared absorber, a colorant, a light stabilizer, a polymerization inhibitor, and a photosensitizer, etc., may be added as necessary.

Further, a solvent may be added to the antiglare layer formation composition, as necessary. As the solvent, one kind or a combination of two or more kinds of the following materials can be used: alcohols such as methanol, ethanol, 1-propanol, 2-propanol, butanol, isopropyl alcohol, and isobutanol, ketones such as acetone, methyl ethyl ketone, cyclohexanone, and methyl isobutyl ketone, ketone alcohols such as diacetone alcohol, aromatic hydrocarbons such as benzene, toluene, and xylene, glycols such as ethylene glycol, propylene glycol, and hexylene glycol, glycol ethers such as ethyl cellosolve, butyl cellosolve, ethyl carbital, butyl carbital, diethyl cellosolve, diethyl carbital, and propylene glycol monomethyl ether, esters such as methyl lactate, ethyl lactate, methyl acetate, ethyl acetate, butyl acetate, and amyl acetate, ethers such as dimethyl ether and diethyl ether, N-methylpyrrolidone, dimethylformamide, etc.

FIG. 2 is a sectional view schematically showing another example of an optical laminate according to the embodiment.

An optical laminate 12 includes a transparent substrate 2, an antiglare layer (first function layer) 3 laminated on one surface of the transparent substrate 2, and a low-refractive-index layer (second function layer) 4 laminated on a surface of the antiglare layer 3 and having a lower refractive index than the antiglare layer 3. The optical laminate 12 is an optical film that, using optical interference and scattering of incident light by minute unevenness on the topmost surface, inhibits ambient light from appearing on the surface and from being reflected (also called “AGLR film”).

The low-refractive-index layer 4 is a function layer that has a lower refractive index than the refractive index of the antiglare layer 3 in the lower layer and inhibits reflection by optical interference.

The low-refractive-index layer 4 can be formed by applying a composition containing an active energy ray-curable compound onto the surface of the antiglare layer 3 and curing the coating film. The low-refractive-index layer 4 may have low-refractive-index fine particles for refractive index adjustment.

As the low-refractive-index fine particles, for example, fine particles of LiF, MgF, 3NaF·AlF, or AlF (each having a refractive index of 1.4), fine particles of Na₃AlF₆ (cryolite, refractive index 1.33), or silica fine particles having hollows therein, can be favorably used. In the silica fine particles having hollows therein, the hollow parts can have a refractive index of air (approximately 1), and therefore the silica fine particles are advantageous in reducing the refractive index of the low-refractive-index layer 4. Specifically, porous silica particles or shell-structure silica particles can be used. The low-refractive-index fine particles are not necessarily needed. In a case where the refractive index after the active energy ray-curable compound is cured is lower than the refractive index of the antiglare layer 3, the low-refractive-index fine particles may be omitted.

As the active energy ray-curable compound, the polymerizable compounds described for the antiglare layer can be used. The polymerization initiator or the solvent described above may be added to the low-refractive-index layer formation composition, as appropriate.

The low-refractive-index layer 4 is a function layer to be the topmost layer, and therefore, as a component for improving stain-proofing property, a stain-proofing agent, a leveling agent, an oil repellent agent, a water repellent agent, and an anti-fingerprint agent are preferably added to the low-refractive-index layer formation composition. As these additives, a fluorine-containing compound or a silicone compound can be favorably used. Besides, various additives such as an antistatic agent, a defoaming agent, an antioxidant, an ultraviolet absorber, an infrared absorber, a colorant, a light stabilizer, a polymerization inhibitor, and a photosensitizer may be added as necessary.

One or more other function layers such as a hard coat layer, a high-refractive-index layer, a middle-refractive-index layer, an antistatic layer, an electromagnetic wave shielding layer, an infrared absorbing layer, an ultraviolet absorbing layer, and a color correcting layer may be laminated between the transparent substrate 2 and the antiglare layer 3.

The application method for the antiglare layer formation composition and the low-refractive-index layer formation composition is not particularly limited. The antiglare layer formation composition and the low-refractive-index layer formation composition may be applied using a spin coater, a roll coater, a reverse roll coater, a gravure coater, a micro-gravure coater, a knife coater, a bar coater, a wire bar coater, a die coater, a dip coater, a spray coater, or an applicator, for example.

Here, the details of the surface uneven shape of the optical laminate according to the present embodiment will be described.

The uneven shape of the topmost surface of the optical laminate according to the present embodiment satisfies the following conditions (1) and (2).

$$800 \leq A \leq 5 , 500 \qquad ( 1 )$$

$$0 < B \leq 100 \qquad ( 2 )$$

Here, A and B are values derived from spatial frequencies f calculated from a predetermined range of an image (power spectrum image) obtained through fast Fourier transform (hereinafter, referred to as “FFT”) of image data generated from measurement data of unevenness heights of the optical laminate surface. A is an average value of power spectrum intensities in a range of 50 cycles/mm≤f≤100 cycles/mm, and B is an average value of power spectrum intensities in a range of 200 cycles/mm≤f≤250 cycles/mm.

The calculation method for the values of A and B is as follows.

First, three-dimensional data of unevenness heights of the topmost surface of the optical laminate is acquired through measurement. The three-dimensional data of the unevenness heights includes positions in the measurement surface and the unevenness heights. The three-dimensional data of the unevenness heights of the topmost surface can be measured through optical interferometry or in a contact manner. The acquired three-dimensional data is transformed to an image (first image) in which the unevenness heights are pixel values. Next, FFT is performed on the first image, to obtain an FFT-processed image (second image). Next, x coordinates of a power spectrum in a predetermined range in the FFT-processed second image are transformed to spatial frequencies f From the obtained spatial frequencies, average values of antilogarithms of power spectrum intensities in a range of 50 cycles/mm≤f≤100 cycles/mm and a range of 200 cycles/mm≤f≤250 cycles/mm are calculated as the values of A and B.

Conventionally, in order to exhibit fingerprint removability, it is general to contain a stain-proofing component such as a fluorine compound or a silicone compound in the topmost surface layer. However, merely adding such a stain-proofing component has a limitation in improving fingerprint removability. Through studies, the present inventors have found that not only the material and the contained components of the topmost surface but also the surface uneven shape has an influence on fingerprint removability. In addition, through studies on uneven shapes that enable improvement in fingerprint removability, the present inventors have found that a power spectrum intensity at around a spatial frequency of 50 cycles/mm is greatly relevant to fingerprint removability, and the higher the power spectrum intensity at around a spatial frequency of 50 cycles/mm is (i.e., the higher the unevenness height is), the more the fingerprint removability is improved.

On the other hand, when the surface unevenness becomes large and the unevenness has a lens shape, sparkle resistance is deteriorated. That is, while fingerprint removability (stain-proofing property) is improved by the uneven shape, sparkle resistance is lowered, and thus it has been found that stain-proofing property and sparkle resistance are in a trade-off relationship.

The optical laminates 11 and 12 according to the present embodiment exhibit excellent fingerprint removability by the uneven shape of the topmost surface satisfying the above conditions (1) and (2). In a case where either the value of A or the value of B is outside the range of the condition (1) or (2), fingerprint removability is deteriorated, or surface scattering increases so that haze increases or the outer appearance is whitened, for example, thus deteriorating optical property. The values of A and B can be controlled through adjustment of the particle size and the amount of the filler to be added to the antiglare layer 3, the amounts of the additives, the thickness of the antiglare layer 3, and the aggregation state of the filler in the film formation process.

By adding a stain-proofing component such as a stain-proofing agent to the function layer to be the topmost layer, fingerprint removability can be further improved.

Sparkle resistance can be evaluated on the basis of the value of a “sparkle contrast” prescribed in JIS C1006: 2019, and if the sparkle contrast is not greater than 3%, sparkle is not visible and sparkle resistance can be evaluated as good.

The sparkle contrast can be calculated as follows. First, a display screen of an image display device lit up in a single color (e.g., green) is captured using an imaging element. Next, from the captured image, a pixel pattern is removed through image processing, to obtain two-dimensional gradation data (sparkle pattern). Next, a standard deviation (sparkle value) of total illuminance distribution data constituting the obtained sparkle pattern is calculated. Then, the percentage of the sparkle value with respect to the average value of the total illuminance distribution data constituting the sparkle pattern is calculated as a sparkle contrast.

The sparkle contrast increases as the definition (ppi) of the image display device becomes higher. With definitions x at two or more different points, sparkle contrasts y are measured, and the values of x and y are plotted to obtain a linear approximation formula y=ax. Then, the value of a is preferably in a range of 0<a<0.015. The values of the definitions x used in measurement include at least values selected from a range of 250 to 270 ppi and a range of 500 to 520 ppi. When the coefficient a of the linear approximation formula is smaller than 0.015, an optical laminate that suppresses a sparkle contrast is obtained even if the optical laminate is used for an image display device having a high definition.

The plotted points (pairs of x and y) for calculating the linear approximation formula may be at least two points. However, setting more plotted points enhances approximation accuracy. Accordingly, it is preferable to use the values of sparkle contrasts y measured with one or more definitions x selected from ranges of, for example, 80 to 99 ppi, 100 to 119 ppi, 120 to 140 ppi, and 160 to 180 ppi, in addition to the values of definitions x selected from the ranges of 250 to 270 ppi and 500 to 520 ppi.

Preferably, the haze value (total haze) of the optical laminate according to the present invention is 1.5 to 35%. The haze value is measured in accordance with JIS K7136. In a case where the haze value is smaller than 1.5%, antiglare property is not obtained and therefore such a haze value is not preferable. In a case where the haze value is greater than 35%, the outer appearance is whitened and therefore such a haze value is not preferable.

The optical laminates 11 and 12 according to the present embodiment can be pasted to a topmost surface of an image display panel such as a liquid crystal panel or an organic EL panel, and thus can be used for composing an image display device. A touch panel may be provided between the image display panel and the optical laminate 11 or 12. The optical laminates 11 and 12 according to the present embodiment are excellent in fingerprint removability, and therefore are suitable as an optical film to be provided to a topmost surface of an image display device having a touch panel.

### EXAMPLES

Hereinafter, Examples in which the present invention was specifically implemented will be described.

### Example 1

### [Antiglare Layer Formation Composition]

Organic fine particles (MX-300 manufactured by Soken Chemical & Engineering Co., Ltd., refractive index 1.49) with an average particle size of 3 μm, and organoclay (SUMECTON-SAN manufactured by Kunimine Industries Co., Ltd.) were stirred in toluene using a paint shaker for 40 minutes so as to be dispersed. 5.0 parts by mass of the organic fine particles, 1.0 parts by mass of the organoclay, 91.0 parts by mass of pentaerythritol triacrylate (PETA; Viscoat #300 manufactured by Osaka Organic Chemical Industry Ltd.), and 3.0 parts by mass of a photopolymerization initiator (Omnirad (registered trademark) 184 manufactured by IGM Resins B.V.) were mixed in toluene so that the total solid content became 50% by mass, and were stirred using a paint shaker for 40 minutes, to obtain an antiglare layer formation composition.

A triacetylcellulose film (TAC film; TG60 manufactured by Fujifilm corporation) with a thickness of 60 μm was used as a transparent substrate. The antiglare layer formation composition was applied to one surface of the transparent substrate using a bar coater, and then dried at 100° C. by a dryer for one minute. Under a nitrogen atmosphere (oxygen concentration of 500 ppm or less), the antiglare layer formation composition was UV-cured using a high-pressure mercury UV device so as to reach a total exposure amount of 200 mJ/cm², thus forming an antiglare layer with a film thickness of 5 μm.

### Example 2

As organic fine particles, 5.0 parts by mass of organic fine particles (refractive index 1.49) with an average particle size of 3 μm and 5.0 parts by mass of organic fine particles (refractive index 1.59) with an average particle size of 5.0 μm were used, without addition of organoclay. For the amount of organic fine particles and the amount of organoclay changed from Example 1, adjustment was made by reducing the amount of pentaerythritol triacrylate so that the total solid content excluding the solvent became 100 parts by mass. An antiglare layer formation composition was prepared in the same manner as in Example 1 except for the above condition. Using the prepared antiglare layer formation composition, an antiglare layer with a film thickness of 8 μm was formed on one surface of a transparent substrate in the same manner as in Example 1.

### Example 3

As organic fine particles, 8.0 parts by mass of organic fine particles (refractive index 1.49) with an average particle size of 5 μm and 10.0 parts by mass of organic fine particles (refractive index 1.59) with an average particle size of 5.0 μm were used, without addition of organoclay. For the amount of organic fine particles and the amount of organoclay changed from Example 1, adjustment was made by reducing the amount of pentaerythritol triacrylate so that the total solid content excluding the solvent became 100 parts by mass. An antiglare layer formation composition was prepared in the same manner as in Example 1 except for the above condition. Using the prepared antiglare layer formation composition, an antiglare layer with a film thickness of 8 μm was formed on one surface of a transparent substrate.

### Example 4

### [Low-Refractive-Index Layer Formation Composition]

45.0 parts by mass of PETA, 50 parts by mass (in solid content ratio) of hollow silica fine particles with an average particle size of 75 nm dispersed in isopropyl alcohol, and 3.0 parts by mass of a photopolymerization initiator, were added, and further, 2.0 parts by mass of a fluorine-based stain-proofing agent (KY-1203 manufactured by Shin-Etsu Chemical Co., Ltd.) was added. The resultant mixture was diluted with an isopropyl alcohol solvent so that the total solid content became 3.5 parts by mass, and then stirred using a paint shaker for 40 minutes, to obtain a low-refractive-index layer formation composition.

An antiglare layer was formed on one surface of a transparent substrate in the same manner as in Example 1. The low-refractive-index layer formation composition was applied to a surface of the antiglare layer using a bar coater, and then dried at 100° C. by a dryer for one minute. Under a nitrogen atmosphere (oxygen concentration 500 ppm or less), the low-refractive-index layer formation composition was UV-cured using a high-pressure mercury UV device so as to reach a total exposure amount of 200 mJ/cm², thus forming a low-refractive-index layer so that an optical film thickness nd (refractive index n×film thickness d) thereof became 550/4 nm.

### Example 5

An antiglare layer was formed on one surface of a transparent substrate in the same manner as in Example 1 except that 5.0 parts by mass of organic fine particles (refractive index 1.59) with an average particle size of 3 μm were used as organic fine particles. Next, a low-refractive-index layer was formed on the antiglare layer in the same manner as in Example 4.

### Example 6

An antiglare layer with a film thickness of 3 μm was formed on one surface of a transparent substrate in the same manner as in Example 1 except that 5.0 parts by mass of organic fine particles (refractive index 1.49) with an average particle size of 1.5 μm were used as organic fine particles. Next, a low-refractive-index layer was formed on the antiglare layer in the same manner as in Example 4.

### Example 7

An antiglare layer with a film thickness of 12 μm was formed on one surface of a transparent substrate in the same manner as in Example 1 except that 5.0 parts by mass of organic fine particles (refractive index 1.59) with an average particle size of 10.0 μm were used as organic fine particles. Next, a low-refractive-index layer was formed on the antiglare layer in the same manner as in Example 4

### Example 8

As organic fine particles, 12.0 parts by mass of organic fine particles (refractive index 1.59) with an average particle size of 0.8 μm were used. For the amount of organic fine particles changed from Example 1, adjustment was made by reducing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Example 9

As organic fine particles, 5.0 parts by mass of organic fine particles (refractive index 1.49) with an average particle size of 2.0 μm and 2.0 parts by mass of organic fine particles (refractive index 1.59) with an average particle size of 2.0 μm were used. For the amount of organic fine particles changed from Example 1, adjustment was made by reducing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Example 10

As organic fine particles, 12.0 parts by mass of organic fine particles (refractive index 1.49) with an average particle size of 2.0 μm and 3.0 parts by mass of organic fine particles (refractive index 1.59) with an average particle size of 3.0 μm were used. For the amount of organic fine particles changed from Example 1, adjustment was made by reducing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Example 11

As organic fine particles, 8.0 parts by mass of organic fine particles (refractive index 1.49) with an average particle size of 3.0 μm and 2.0 parts by mass of organic fine particles (refractive index 1.59) with an average particle size of 3.0 μm were used. For the amount of organic fine particles changed from Example 1, adjustment was made by reducing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Example 12

As organic fine particles, 10.0 parts by mass of organic fine particles (refractive index 1.59) with an average particle size of 3.0 μm were used. For the amount of organic fine particles changed from Example 1, adjustment was made by reducing the amount of pentaerythritol triacrylate so that the total solid content excluding the solvent became 100 parts by mass. An antiglare layer with a film thickness of 5 μm was formed on one surface of a transparent substrate in the same manner as in Example 1 except for the above condition. Next, a low-refractive-index layer was formed on the antiglare layer in the same manner as in Example 4.

### Example 13

As organic fine particles, 8.0 parts by mass of organic fine particles (refractive index 1.59) with an average particle size of 5.0 μm were used. For the amount of organic fine particles changed from Example 1, adjustment was made by reducing the amount of pentaerythritol triacrylate so that the total solid content excluding the solvent became 100 parts by mass. An antiglare layer with a film thickness of 6 μm was formed on one surface of a transparent substrate in the same manner as in Example 1 except for the above condition. Next, a low-refractive-index layer was formed on the antiglare layer in the same manner as in Example 4.

### Comparative Example 1

As organic fine particles, 15.0 parts by mass of organic fine particles (refractive index 1.59) with an average particle size of 8.0 μm were used. For the amount of organic fine particles changed from Example 1, adjustment was made by reducing the amount of pentaerythritol triacrylate so that the total solid content excluding the solvent became 100 parts by mass. An antiglare layer with a film thickness of 5 μm was formed on one surface of a transparent substrate in the same manner as in Example 1 except for the above condition.

### Comparative Example 2

As organic fine particles, change was made to 2.0 parts by mass of organic fine particles (refractive index 1.49) with an average particle size of 3.0 μm. For the amount of organic fine particles changed from Example 1, adjustment was made by increasing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition.

### Comparative Example 3

As organic fine particles, change was made to 2.0 parts by mass of organic fine particles (refractive index 1.59) with an average particle size of 0.8 μm. For the amount of organic fine particles changed from Example 1, adjustment was made by increasing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Comparative Example 4

As organic fine particles, change was made to 2.0 parts by mass of organic fine particles (refractive index 1.49) with an average particle size of 1.5 μm. For the amount of organic fine particles changed from Example 1, adjustment was made by increasing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Comparative Example 5

As organic fine particles, change was made to 2.0 parts by mass of organic fine particles (refractive index 1.49) with an average particle size of 2.0 μm. For the amount of organic fine particles changed from Example 1, adjustment was made by increasing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Comparative Example 6

As organic fine particles, change was made to 15.0 parts by mass of organic fine particles (refractive index 1.49) with an average particle size of 2.0 μm and 5.0 parts by mass of organic fine particles (refractive index 1.59) with an average particle size of 2.0 μm. For the amount of organic fine particles changed from Example 1, adjustment was made by reducing the amount of pentaerythritol triacrylate so that the total solid content excluding the solvent became 100 parts by mass. An antiglare layer with a film thickness of 5 μm was formed on one surface of a transparent substrate in the same manner as in Example 1 except for the above condition. Next, a low-refractive-index layer was formed on the antiglare layer in the same manner as in Example 4.

### Comparative Example 7

As organic fine particles, change was made to 8.0 parts by mass of organic fine particles (refractive index 1.49) with an average particle size of 3.0 μm and 8.0 parts by mass of organic fine particles (refractive index 1.59) with an average particle size of 3.0 μm. For the amount of organic fine particles changed from Example 1, adjustment was made by reducing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Comparative Example 8

As organic fine particles, change was made to 10.0 parts by mass of organic fine particles (refractive index 1.49) with an average particle size of 5.0 μm and 2.0 parts by mass of organic fine particles (refractive index 1.59) with an average particle size of 5.0 μm. For the amount of organic fine particles changed from Example 1, adjustment was made by reducing the amount of pentaerythritol triacrylate so that the total solid content excluding the solvent became 100 parts by mass. An antiglare layer with a film thickness of 6.5 μm was formed on one surface of a transparent substrate in the same manner as in Example 1 except for the above condition. Next, a low-refractive-index layer was formed on the antiglare layer in the same manner as in Example 4.

### Comparative Example 9

As organic fine particles, change was made to 8.0 parts by mass of organic fine particles (refractive index 1.49) with an average particle size of 15.0 μm. For the amount of organic fine particles changed from Example 1, adjustment was made by reducing the amount of pentaerythritol triacrylate so that the total solid content excluding the solvent became 100 parts by mass. An antiglare layer with a film thickness of 17 μm was formed on one surface of a transparent substrate in the same manner as in Example 1 except for the above condition. Next, a low-refractive-index layer was formed on the antiglare layer in the same manner as in Example 4.

### Comparative Example 10

As organic fine particles, change was made to 12.0 parts by mass of organic fine particles (refractive index 1.59) with an average particle size of 3.0 μm. For the amount of organic fine particles changed from Example 1, adjustment was made by reducing the amount of pentaerythritol triacrylate so that the total solid content excluding the solvent became 100 parts by mass. An antiglare layer with a film thickness of 4 μm was formed on one surface of a transparent substrate in the same manner as in Example 1 except for the above condition. Next, a low-refractive-index layer was formed on the antiglare layer in the same manner as in Example 4.

### Comparative Example 11

As organic fine particles, change was made to 12.0 parts by mass of organic fine particles (refractive index 1.59) with an average particle size of 5.0 μm. For the amount of organic fine particles changed from Example 1, adjustment was made by reducing the amount of pentaerythritol triacrylate so that the total solid content excluding the solvent became 100 parts by mass. An antiglare layer with a film thickness of 6.5 μm was formed through the same procedure as in Example 1 except for the above condition. Next, a low-refractive-index layer was formed on the antiglare layer in the same manner as in Example 4.

### Comparative Example 12

As organic fine particles, change was made to 12.0 parts by mass of organic fine particles (refractive index 1.59) with an average particle size of 10.0 μm. For the amount of organic fine particles changed from Example 1, adjustment was made by reducing the amount of pentaerythritol triacrylate so that the total solid content excluding the solvent became 100 parts by mass. An antiglare layer with a film thickness of 12 μm was formed on one surface of a transparent substrate in the same manner as in Example 1 except for the above condition. Next, a low-refractive-index layer was formed on the antiglare layer in the same manner as in Example 4.

The optical laminates according to the Examples and the Comparative Examples were evaluated as follows.

### <Evaluation 1: Surface Uneven Shape>

### (Acquisition of Three-Dimensional Data)

Three-dimensional data of the uneven shape of the topmost surface of each optical laminate was measured by optical interferometry using Vertscan (R3300H Lite manufactured by Ryoka systems Inc.). The measurement condition was as follows. Unevenness heights were measured based on the lowest position in the measurement area.
Camera model: Sony HR-50 1/3
Objective lens magnification: SXTI
Tube: 1×
Zoom lens: 1×
Light source: 530 white
Wavelength filter: 520 nm
Measurement device: piezo
Measurement mode: phase
Scan speed: 4 μm/see
Scan range: 10 μm to −10 μm
Number of effective pixels: 0%
Measurement area: 940.8 μm×705.6 μm, 640 pixels×480 pixels
XY direction resolution: 1 pixel 1.47 μm

### (FFT Analysis)

FFT analysis was performed using free software “ImageJ 1.53h” under an environment of Windows (registered trademark) 10. The procedure was as follows.
1. Three-dimensional data was transformed to TIFF image data in which heights were pixel values.
2. With reference to the original three-dimensional data values (measured values of heights), FFT was performed. The size of the FFT-processed image was 1024 pixels×1024 pixels.
3. The FFT-processed image was subjected to processing of restoring power spectrum intensities to actual measured values.
4. On the processed image, a range of ±20 pixels from a positive part of an x axis passing through an origin was designated and power spectrum intensities were outputted.
5. The x coordinates on the outputted power spectrum were transformed to spatial frequencies f on the basis of the pixel size of the original three-dimensional data.
6. From the calculated spatial frequencies, average values (values of A and B) of antilogarithms of power spectrum intensities in respective ranges of 50 cycles/mm≤f≤100 cycles/mm and 200 cycles/mm≤f≤250 cycles/mm were calculated.

The above FFT on the three-dimensional data is processing for decomposing a wave formed by height change of the surface of the optical laminate into spatial frequency components.

In the step 1, a grayscale image which represents height information by light-dark shades at predetermined gradation levels may be generated from the above three-dimensional data. Specifically, height information is transformed to values representing light-dark shades at 256 gradation levels from a minimum value of 0 to a maximum value of 255, whereby a grayscale image can be generated. In this case, in the step 2, two-dimensional Fourier transform was performed on the obtained grayscale image. Power spectrum intensities obtained through the two-dimensional Fourier transform were subjected to transform opposite to transform from height information to light-dark shades, whereby the power spectrum intensities are restored to values corresponding to heights. Thus, data that has undergone fast Fourier transform on height information of unevenness at respective positions on the surface of the optical laminate, is obtained.

Instead of performing transform to values representing light-dark shades in the step 1, in the step 2, the height information itself may be treated as a processing target and subjected to two-dimensional Fourier transform.

The number of data of the three-dimensional data, the number of pixels of the grayscale image, and the number of pixels of the FFT image which is a power spectrum are not particularly limited. For example, in a case where an image of 640 pixels×480 pixels is subjected to two-dimensional Fourier transform to generate an FFT image of 1024 pixels×1024 pixels, decomposition of height data in 480 rows into 1024 frequencies is performed for each row, and then, with rows and columns transposed, decomposition of height data in 640 columns into 1024 frequencies is performed for each column. Thus, an FFT image of 1024 pixels×1024 pixels is obtained.

A procedure in which FFT analysis was performed using image analysis software “ImageJ 1.53h” is described below.
(1) Three-dimensional data was taken into the image analysis software, as TIFF image data.
(2) On the image analysis software, “FFT Options” was selected and “Raw power spectrum” was checked. Then, processing of fast Fourier transform was executed. Thus, an image “FFT of (file name)” and an image “PS of (file name)” were opened. The size of each image was 1024 pixels×1024 pixels. The “FFT of (file name)” image is an image represented by normalizing the power spectrum intensities into light-dark shades at 256 gradation levels, and the “PS of (file name)” image is an image in which the power spectrum intensities are transformed to values corresponding to heights in the three-dimensional data.
(3) The “FFT of (file name)” image was closed, and commands “Log” and “code: v=v/2.303;” of “Macro . . . ” were performed on the “PS of (file name)” image. Thus, the z axis indicating the power spectrum intensities and the values thereof were transformed to common logarithms.
(4) On the image processed in the above (3), an x axis was set in a horizontal direction passing through an origin set at an image center, and a range of ±20 pixels in the vertical direction from the x axis in a region of x>0 was designated, and power spectrum intensities at the respective pixels were outputted. Then, an average value of the power spectrum intensities for the pixels at the same x coordinate was calculated, and the calculated average value was used as the power spectrum intensity at each x coordinate.
(5) The x coordinates of the outputted power spectrum intensities were transformed to spatial frequencies with a unit length set at 1 mm, on the basis of the pixel size of the three-dimensional data.
(6) Each of intensity integral values A and B was calculated from the power spectrum intensities at the spatial frequencies.

### <Evaluation 2. Fingerprint Removability Evaluation>

Each obtained optical laminate was pasted to a blackboard using an optical adhesive, with the function surface of the optical laminate facing outward, and artificial leather with an olive oil reagent deposited thereon was pressed against the function surface, to deposit olive oil on the function surface. The deposited olive oil was repeatedly wiped off using tissue paper (SCOTTIE (registered trademark) manufactured by Nippon Paper Crecia Co., Ltd.) with a load of 1 kg, and every time wiping was performed, the olive oil deposited part was subjected to reflection spectroscopic measurement by a spectrophotometer (CM-2500d manufactured by Konica Minolta). A color difference ΔE*ab between before olive oil was deposited and after wiping was performed was calculated, and on the basis of the number of times of wiping until the color difference ΔE*ab reached 0.5 or smaller, fingerprint removability was evaluated in accordance with the following criteria.
5 (Very good): number of times of wiping≤9
4 (Fairly good): 9<number of times of wiping≤12
3 (Good): 12<number of times of wiping≤15
2 (Not good): 15<number of times of wiping≤20
1 (Poor): 20<number of times of wiping

The measurement condition in the reflection spectroscopic measurement was as follows.
Measurement area: 18 mm
Item: SCI/SCE
Light source: D65
UV setting: 100%
Observation field: 10°

### <Evaluation 3. Sparkle Evaluation>

Each obtained optical laminate was placed on metal masks having six kinds of lattice patterns (85, 106, 127, 169, 254, 508 ppi) different in definition, and sparkle contrasts were measured by single-image measurement using a sparkle measurement system SMS-1000 (manufactured by DM&S) (in accordance with JIS C1006:2019). With the horizontal axis set as definition and the vertical axis set as sparkle contrast, the definitions of the used metal masks and the measured values of the sparkle contrasts were plotted and a slope a of a linear approximation formula was calculated. On the basis of the calculated slope a, sparkle resistance was evaluated in accordance with the following criteria.
⊚ (Very good): 0<a<0.010
∘ (Good): 0.010≤a<0.015
x (Poor): 0.015≤a

### <Evaluation 4. Antiglare Property Evaluation>

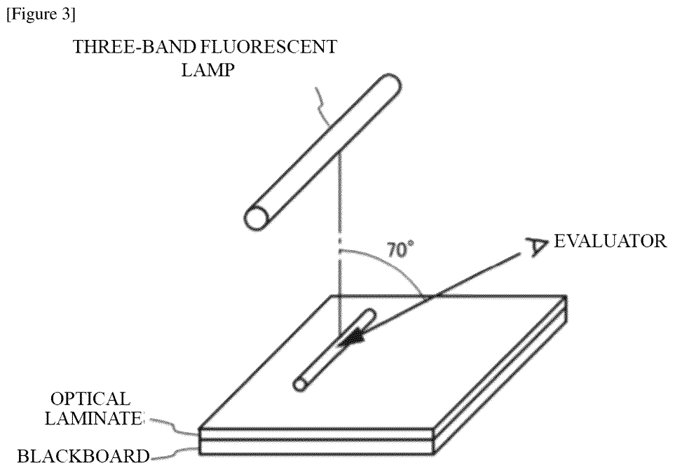

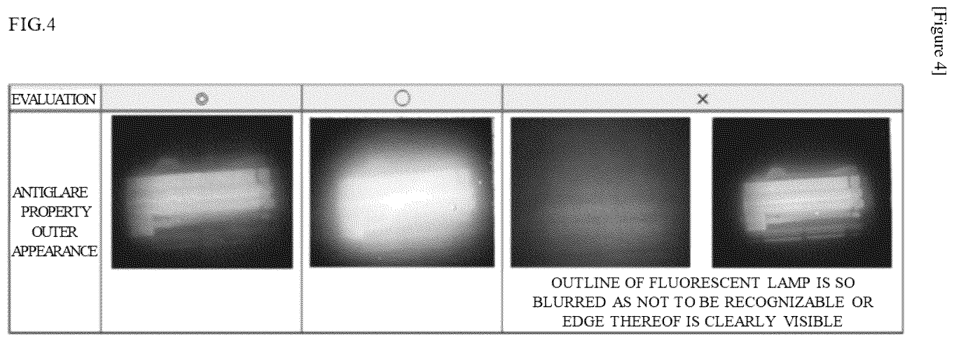

FIG. 3 shows an evaluation method for antiglare property, and FIG. 4 shows an evaluation example of antiglare property.

Each obtained optical laminate was pasted to a blackboard using an optical adhesive, with the function surface of the optical laminate facing outward. A three-band fluorescent lamp and the optical laminate were placed so that light was vertically applied to the function surface. The surface of the optical laminate was observed from a direction in which a line connecting a viewpoint and an image of the three-band fluorescent lamp appearing on the function surface had an angle of 70° with respect to a perpendicular extending from the three-band fluorescent lamp to the function surface, and antiglare property was evaluated on the basis of the following criteria (see FIG. 4).
⊚: The outline of the three-band fluorescent lamp is recognizable and the edge thereof is visible but blurred.
∘: The outline of the three-band fluorescent lamp is recognizable but the edge thereof is blurred and obscure.
x: The outline of the three-band fluorescent lamp is so blurred as not to be recognizable or the edge thereof is clearly visible.

### <Haze>

Haze was measured using a haze meter (NDH7000 manufactured by Nippon Denshoku Industries Co., Ltd.) in accordance with a haze testing method in a plastic optical characteristics testing method JIS K 7136.

Table 1 and Table 2 show evaluation results.

TABLE 1

| | | | Organic | First | | | | | | | |
|---|---|---|---|---|---|---|---|---|---|---|---|
| | | | fine | function | | | | | | | |
| | Layer structure | | particle | layer | | | | Sparkle evaluation | | | |
| | First | Second | Particle | Film | Surface | | | Approximation | | | |
| | function | function | size | thickness | unevenness | | Fingerprint | line | Sparkle | Haze | Antiglare |
| | layer | layer | (μm) | (um) | A | B | resistance | Slope a | resistance | (%) | property |
| Example | ◯ | — | 3 | 5 | 5249 | 95 | 3 | 0.0102 | ◯ | 7 | ⊚ |
| 1 | | | | | | | | | | | |
| Example | ◯ | — | 3&5 | 8 | 1633 | 6 | 5 | 0.0063 | ⊚ | 15 | ⊚ |
| 2 | | | | | | | | | | | |
| Example | ◯ | — | 5 | 8 | 2905 | 13 | 5 | 0.0032 | ⊚ | 20 | ⊚ |
| 3 | | | | | | | | | | | |
| Example | ◯ | ◯ | 3 | 5 | 1696 | 50 | 3 | 0.0123 | ◯ | 5 | ⊚ |
| 4 | | | | | | | | | | | |
| Example | ◯ | ◯ | 3 | 5 | 891 | 8 | 3 | 0.0103 | ◯ | 22 | ⊚ |
| 5 | | | | | | | | | | | |
| Example | ◯ | ◯ | 1.5 | 3 | 1106 | 27 | 3 | 0.0076 | ⊚ | 4 | ◯ |
| 6 | | | | | | | | | | | |
| Example | ◯ | ◯ | 10 | 12 | 1231 | 18 | 4 | 0.0128 | ◯ | 20 | ◯ |
| 7 | | | | | | | | | | | |
| Example | ◯ | ◯ | 0.8 | 4 | 4050 | 31 | 4 | 0.0112 | ◯ | 4 | ◯ |
| 8 | | | | | | | | | | | |
| Example | ◯ | ◯ | 2 | 4 | 1263 | 98 | 3 | 0.0062 | ⊚ | 8 | ⊚ |
| 9 | | | | | | | | | | | |
| Example | ◯ | ◯ | 2&3 | 4 | 1655 | 22 | 5 | 0.0093 | ⊚ | 9 | ⊚ |
| 10 | | | | | | | | | | | |
| Example | ◯ | ◯ | 3 | 4 | 2247 | 18 | 5 | 0.0122 | ◯ | 7 | ⊚ |
| 11 | | | | | | | | | | | |
| Example | ◯ | ◯ | 3 | 5 | 1717 | 91 | 4 | 0.0093 | ⊚ | 30 | ⊚ |
| 12 | | | | | | | | | | | |
| Example | ◯ | ◯ | 5 | 6 | 3121 | 54 | 4 | 0.0087 | ⊚ | 25 | ◯ |
| 13 | | | | | | | | | | | |

TABLE 2

| | | | Organic | First | | | | | | | |
|---|---|---|---|---|---|---|---|---|---|---|---|
| | | | fine | function | | | | | | | |
| | Layer structure | | particle | layer | | | | Sparkle evaluation | | | |
| | First | Second | Particle | Film | Surface | | | Approximation | | | |
| | function | function | size | thickness | unevenness | | Fingerprint | line | Sparkle | Haze | Antiglare |
| | layer | layer | (μm) | (μm) | A | B | resistance | Slope a | resistance | (%) | property |
| Comparative | ◯ | — | 8 | 5 | 15219 | 1073 | 5 | 0.0152 | X | 30 | X |
| Example | | | | | | | | | | | |
| 1 | | | | | | | | | | | |
| Comparative | ◯ | — | 3 | 4 | 789 | 21 | 2 | 0.0079 | ⊚ | 1 | X |
| Example | | | | | | | | | | | |
| 2 | | | | | | | | | | | |
| Comparative | ◯ | ◯ | 0.8 | 4 | 41 | 2 | 1 | 0.0030 | ⊚ | 5 | X |
| Example | | | | | | | | | | | |
| 3 | | | | | | | | | | | |
| Comparative | ◯ | ◯ | 1.5 | 4 | 187 | 44 | 1 | 0.0038 | ⊚ | 1 | X |
| Example | | | | | | | | | | | |
| 4 | | | | | | | | | | | |
| Comparative | ◯ | ◯ | 2 | 4 | 404 | 8 | 2 | 0.0040 | ⊚ | 1 | X |
| Example | | | | | | | | | | | |
| 5 | | | | | | | | | | | |
| Comparative | ◯ | ◯ | 2 | 5 | 5831 | 42 | 5 | 0.0152 | X | 10 | X |
| Example | | | | | | | | | | | |
| 6 | | | | | | | | | | | |
| Comparative | ◯ | ◯ | 3 | 4 | 5628 | 92 | 5 | 0.0170 | X | 17 | X |
| Example | | | | | | | | | | | |
| 7 | | | | | | | | | | | |
| Comparative | ◯ | ◯ | 5 | 6.5 | 19614 | 302 | 5 | 0.0201 | X | 14 | X |
| Example | | | | | | | | | | | |
| 8 | | | | | | | | | | | |
| Comparative | ◯ | ◯ | 15 | 17 | 8105 | 192 | 5 | 0.0176 | X | 13 | X |
| Example | | | | | | | | | | | |
| 9 | | | | | | | | | | | |
| Comparative | ◯ | ◯ | 3 | 4 | 5903 | 144 | 5 | 0.0091 | ⊚ | 45 | X |
| Example | | | | | | | | | | | |
| 10 | | | | | | | | | | | |
| Comparative | ◯ | ◯ | 5 | 6.5 | 6100 | 214 | 4 | 0.0075 | ⊚ | 45 | X |
| Example | | | | | | | | | | | |
| 11 | | | | | | | | | | | |
| Comparative | ◯ | ◯ | 10 | 12 | 555777 | 14790 | 5 | 0.0059 | ⊚ | 62 | X |
| Example | | | | | | | | | | | |
| 12 | | | | | | | | | | | |

As shown in Table 1, in the optical laminates according to Examples 1 to 13, A and B satisfied the conditions (1) and (2), and antiglare property, fingerprint removability, and sparkle resistance were all excellent. Sparkle resistance evaluated on the basis of the slope a of the approximation line indicates that sparkle resistance is less likely to be deteriorated even if the definition of the display device becomes high.

On the other hand, in the optical laminates according to Comparative Examples 1 to 12, one or both of A and B did not satisfy the above conditions, desired antiglare property was not obtained, and fingerprint removability or sparkle resistance was low.

From the above, it has been confirmed that an optical laminate that is excellent in optical property and fingerprint removability can be realized by the above values A and B satisfying both of the conditions (1) and (2).

The present invention is applicable as an optical film provided to a topmost surface of an image display device.

While the present invention has been described in detail, the foregoing description is in all aspects illustrative and not restrictive. It will be understood that numerous other modifications and variations can be devised without departing from the scope of the disclosure.

What is claimed is:

1. An optical laminate having an uneven shape on a topmost surface thereof, wherein
the following conditions (1) and (2) are satisfied:
$$800 \leq A \leq 5 , 500 \qquad ( 1 )$$
$$0 < B \leq 100 \qquad ( 2 )$$
where,
when three-dimensional data of unevenness heights obtained by measuring the uneven shape through optical interferometry or in a contact manner is transformed to first image data in which the unevenness heights are pixel values, the first image data is transformed to a second image through fast Fourier transform, and spatial frequencies f at x coordinates of a power spectrum of an image in a range of ±20 pixels from a positive part of an x axis passing through an origin on the second image are calculated,
A is an average value of power spectrum intensities in a range of 50 cycles/mm≤f≤100 cycles/mm, and
B is an average value of power spectrum intensities in a range of 200 cycles/mm≤f≤250 cycles/mm.

2. The optical laminate according to claim 1, wherein
when sparkle contrasts y are measured with lattice patterns having two kinds of definitions x selected from a range of 250 to 270 ppi and a range of 500 to 520 ppi, and a linear approximation formula obtained from plotted values of x and y is defined as y=ax, 0<a<0.015 is satisfied.

3. The optical laminate according to claim 1, wherein
a haze value measured in accordance with JIS K7136 is 1.5 to 35%.

4. The optical laminate according to claim 1, comprising:
a transparent substrate; and
at least one function layer laminated on at least one surface of the transparent substrate, wherein
the uneven shape is formed by the function layer.

5. The optical laminate according to claim 4, wherein
the function layer includes
a first function layer forming the uneven shape, and
a second function layer laminated on the first function layer and having a lower refractive index than the first function layer.

6. The optical laminate according to claim 5, wherein
the second function layer contains a stain-proofing agent.

7. The optical laminate according to claim 6, wherein
the stain-proofing agent contains a fluorine-containing compound or a silicone compound.

8. The optical laminate according to claim 5, wherein
the first function layer contains organic fine particles with a particle size of 0.5 to 10 μm.

9. An image display device comprising the optical laminate according to claim 1.
